(19) United States
(12) Patent Application Publication
(10) Pub. No.: US 2015/0181302 A1
(43) Pub. Date: Jun. 25, 2015

(54) Electronic Apparatus, Object Information Search Method of Video Playing in the Electronic Apparatus, and Non-Transitory Tangible Computer Readable Medium Thereof

(71) Applicant: Chao-Yu Yueh, Taipei City (TW)

(72) Inventor: Chao-Yu Yueh, Taipei City (TW)

(21) Appl. No.: 14/542,863

(22) Filed: Nov. 17, 2014

(30) Foreign Application Priority Data
Dec. 23, 2013 (TW) 102147695

(51) Int. Cl. H04N 21/478; H04N 21/44; H04N 21/239; H04N 21/258; H04N 21/235; H04N 21/437; H04N 21/61; H04N 21/462

(52) U.S. Cl. CPC H04N 21/47815; H04N 21/6125; H04N 21/44008; H04N 21/4622; H04N 21/25891; H04N 21/2353; H04N 21/437; H04N 21/2393

(57) ABSTRACT

An electronic apparatus, an object information search method of video played in the electronic apparatus, and a non-transitory tangible computer readable medium thereof are provided. The video comprises a plurality of frames. One of the frames has an object. The electronic comprises a display unit, an input unit, and a processor electrically connected to the input unit. The display unit receives a video signal having the video, and plays the video according to the video signal. The input unit generates an input signal in response to a selection of the object. The processor receives the video signal and the input signal, identifies the object to obtain an identify result according to the video signal and the input signal, retrieves targeted object information related to the object according to the identify result, and transmits the targeted object information to the display unit or a user device.

This application claims the benefit of priority based on Taiwan Patent Application No 102147695, filed on Dec. 23, 2013, the contents of which are incorporated herein by reference in their entirety.

### CROSS-REFERENCES TO RELATED APPLICATIONS

Not applicable.

### BACKGROUND OF THE INVENTION

1. Field of the Invention

The present invention is related to an electronic apparatus, an object information search method of video played in the electronic apparatus, and a non-transitory tangible computer readable medium thereof; and more particularly, the present invention is related to an electronic apparatus, an object information search method of video played in the electronic apparatus, and a non-transitory tangible computer readable medium thereof for identifying a selected object in video, retrieving targeted object information related to the selected object according to the identify result, and transmitting the targeted object information.

2. Descriptions of the Related Art

With the development of Internet, people could retrieve information from Internet through various electronic devices, such as smart mobile communication devices or smart appliances.

For example, in daily life, when a user is interested in a product shown in playing video and wants to get information of specifications of the product or stores which could purchase the product, the user needs to approximately record the category and the appearance of the product, and then searches information related to the product from Internet through an electronic device which is connected to Internet.

However, the aforesaid action for searching product information requires the user to manually record the category and the appearance of the product, and then manually search information related to the product from Internet. Therefore, the record for the category and the appearance of the product from the user will affect the speed and accuracy for searching information of the product. In addition, when the user is interested in multiple products shown in the playing video, the user needs to record the category and the appearance of each product one by one in a short time, and then search information related to each product from Internet. Thus, the record for the category and the appearance of the product from the user will be rougher to further reduce the speed and accuracy for searching information of each product.

In view of this, it is important to provide a more convenient information searching method, such that the user could retrieve information related to interested products quickly and accurately.

### SUMMARY OF THE INVENTION

An objective of the present invention is to provide an electronic apparatus for searching object information of video. The video comprises a plurality of frames. One of the frames has at least one object.

To achieve the aforesaid objective, the electronic apparatus of the present invention comprises a display unit, an input unit, and a processor. The display unit receives a video signal having video, and plays the video according to the video signal. The input unit generates an input signal in response to a selection of the at least one object from a user. The processor which is electrically connected to the display unit and the input unit receives the video signal and the input signal, identifies the at least one object to obtain an identify result according to the video signal and the input signal, retrieves targeted object information related to the at least one object according to the identify result, and transmits the targeted object information to the display unit or a user device.

Another objective of the present invention is to provide an object information search method of video played in the aforesaid electronic apparatus, which comprises the following steps of: receiving a video signal having video; playing the video according to the video signal; generating an input signal in response to a selection of the at least one object; receiving the video signal and the input signal; identifying the at least one object to obtain an identify result according to the video signal and the input signal; retrieving targeted object information related to the at least one object according to the identify result; and transmitting the targeted object information to the display unit or a user device.

Yet a further objective of the present invention is to provide a non-transitory tangible computer readable medium, which stores a program executing an object information search method of video played in the aforesaid electronic apparatus. When the program is loaded into the electronic apparatus, the aforesaid object information search method of video will be executed and accomplished.

According to the above description, when playing video comprising a plurality of frames, the electronic apparatus according to the present invention can retrieve targeted object information related to an object selected by a user in one of the frames of the video. Then the electronic apparatus displays the targeted object information related to the object, or transmits the targeted object information related to the object to a predetermined user device. Accordingly, the electronic apparatus of the present invention can effectively overcome the problem of the prior art that, the record for the category and the appearance of various products from a user is rougher to reduce the speed and accuracy for searching information of each product.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of an electronic apparatus and video played in the electronic apparatus;

FIG. 2 is a schematic view of Internet, a user device, and a first embodiment of an electronic apparatus of the present invention;

FIG. 3A is a schematic view of a plurality of frames of the video shown in FIG. 1;

FIG. 3B is a schematic view of one of the frames shown in FIG. 3A;

FIG. 4A is a schematic view of the electronic apparatus, video and targeted object information displayed in the electronic apparatus shown in FIG. 2;

FIG. 4B is a schematic view of the user device and targeted object information displayed in the user device shown in FIG. 2;

FIG. 5 is a schematic view of Internet, a user device, and a second embodiment of an electronic apparatus of the present invention;

FIG. 6 is a flowchart of a third embodiment of the present invention;

FIG. 7 is another flowchart of the third embodiment of the present invention; and

FIG. 8 is a flowchart of a fourth embodiment of the present invention.

### DESCRIPTION OF THE PREFERRED EMBODIMENT

In the following description, this invention will be explained with reference to embodiments thereof. However, the description of these embodiments is only for purposes of illustration rather than limitation. It should be appreciated that in the following embodiments and attached drawings, elements unrelated to this invention are omitted from depictions; and dimensional relationships among individual elements in the attached drawings are illustrated only for ease of understanding, but not to limit the actual scale.

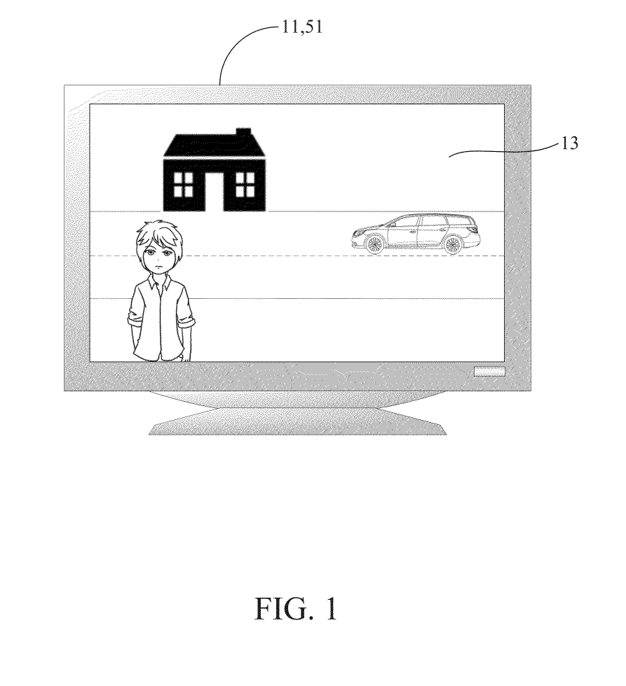

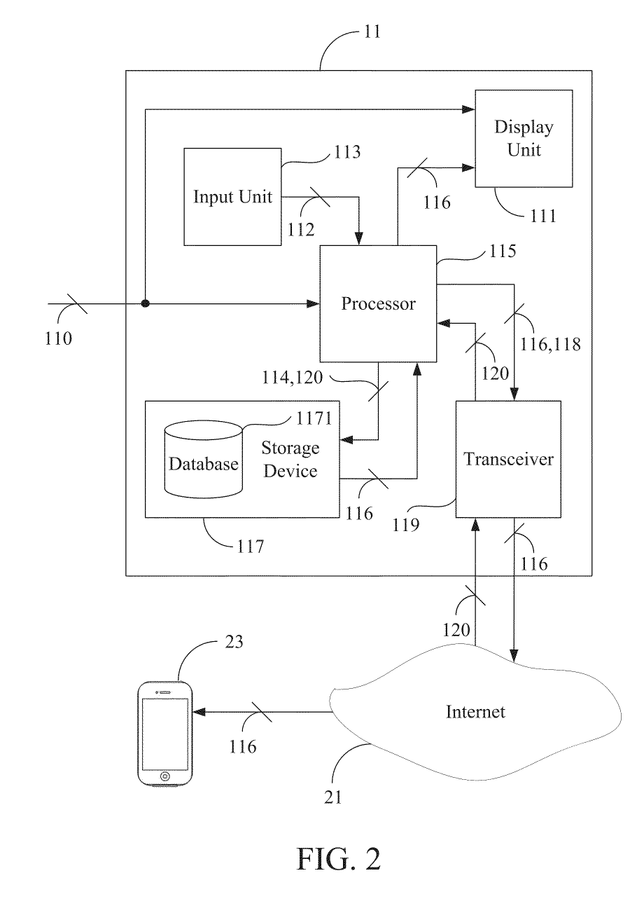

FIG. 1 depicts an electronic apparatus 11, 51 of the present invention and video 13 played in the electronic apparatus 11, 51. FIG. 2 depicts Internet 21, a user device 23, and a first embodiment of the present invention, which is the electronic apparatus 11. The electronic apparatus 11 may be a smart TV, a smartphone, a personal digital assistant (PDA), a laptop, or a device with ability to play video and be connected to Internet. The user device 23 may be a smartphone, a personal digital assistant (PDA), a laptop, or a device with ability to play video and be connected to Internet. In the embodiment, the electronic apparatus 11 is a smart TV, and the user device 23 is a smartphone.

Refer to FIG. 2, the electronic apparatus 11 comprises a display unit 111, an input unit 113, a processor 115, a storage device 117, and a transceiver 119. The processor 115 is electrically connected to the display unit 111, the input unit 113, the storage device 117, and the transceiver 119. In the embodiment, the input unit 113 is a touch input unit. However, in other embodiments, the input unit 113 may be a wireless remote control with a click inputting function or a somatosensory device. It should be noted that the input unit 113 is not limited to be a touch input unit in the present invention. The storage device 117 which stores a database 1171 may be a flash memory, a hard disk, or any other storage media with the same function and well known to those skilled in the art.

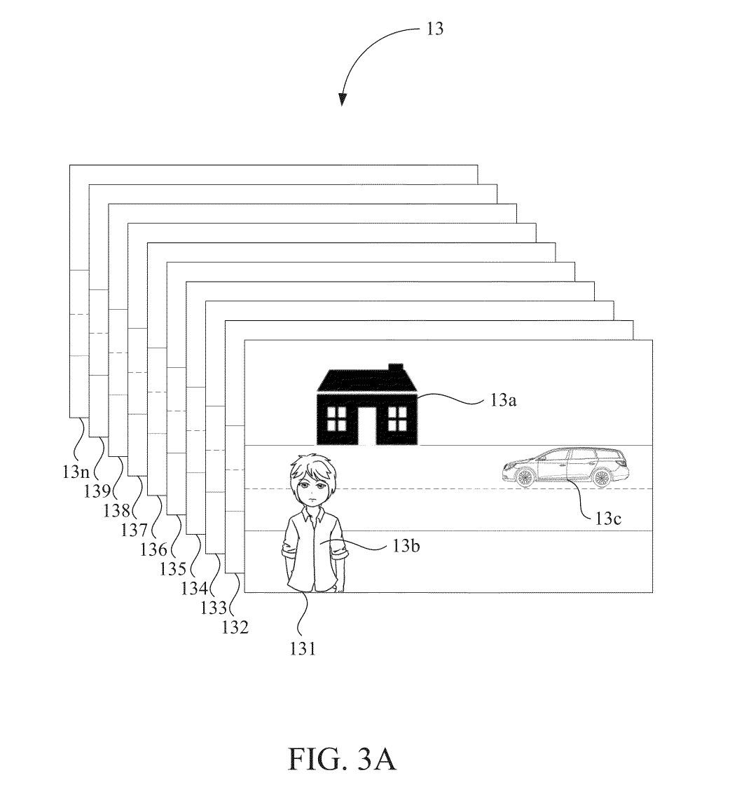

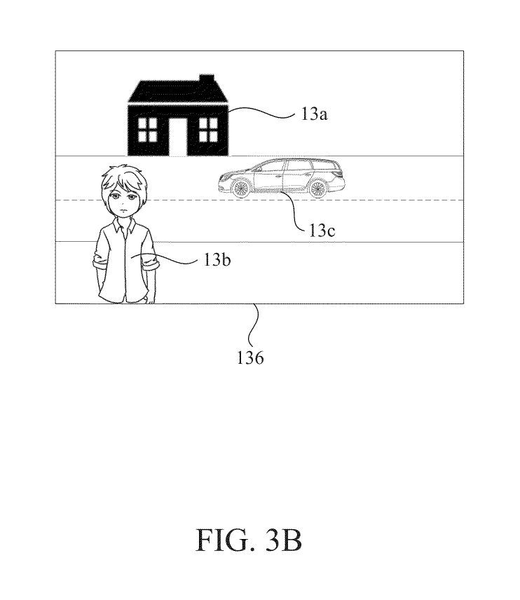

The display unit 111 receives a video signal 110 having the video 13, and playing the video 13 according to the video signal 110. As shown in FIG. 3A, the video 13 comprises a plurality of frames 131, 132, 133, . . . , 13n. Each of the frames 131, 132, 133, . . . , 13n has a plurality of objects 13a, 13b, 13c. In the embodiment, Each of the frames 131, 132, 133, . . . , 13n of the video 13 has three objects 13a, 13b, 13c. However, in other embodiments, each of the frames of the video 13 may has any number of the objects according to the contents of the video 13. It should be noted that the video 13 is not limited to have three objects 13a, 13b, 13c in the present invention.

When the display unit 111 displays the frame 136 of the video 13 as shown in FIG. 3B and a user selects the object 13b through the input unit 113, the input unit 113 generates an input signal 112 in response to the selection of the object 13b and transmits the input signal 112 to the processor 115. After receiving the video signal 110 and the input signal 112, the processor 115 identifies the object 13b to obtain an identify result according to the video signal 110 and the input signal 112. The processor 115 generates a search signal 114 and transmits the search signal 114 to the storage device 117.

The database 1171 of the storage device 117 stores a plurality of object information. After receiving the search signal 114, the storage device 117 retrieves targeted object information 116 related to the object 13b from the plurality of object information stored in the database 1171 according to the search signal 114 and transmits the targeted object information 116 to the processor 115. Afterward, the processor 115 transmits the targeted object information 116 to the display unit 111 and the transceiver 119.

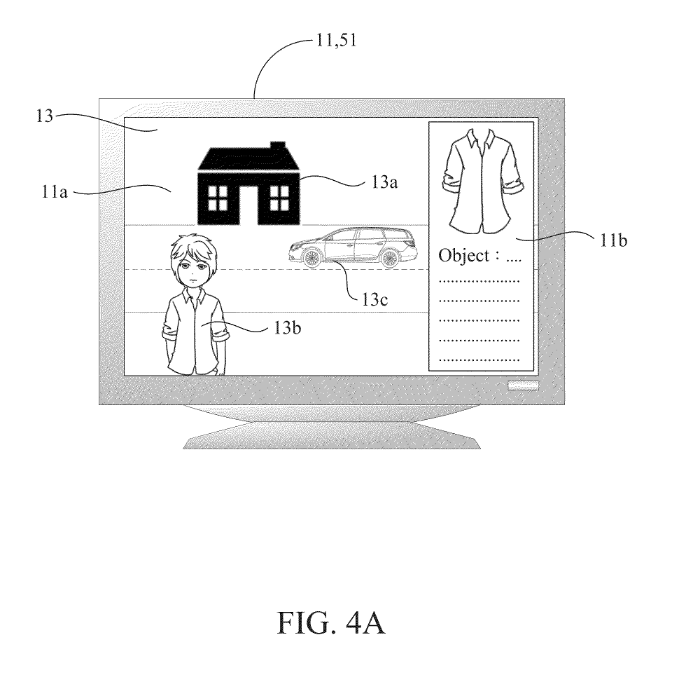

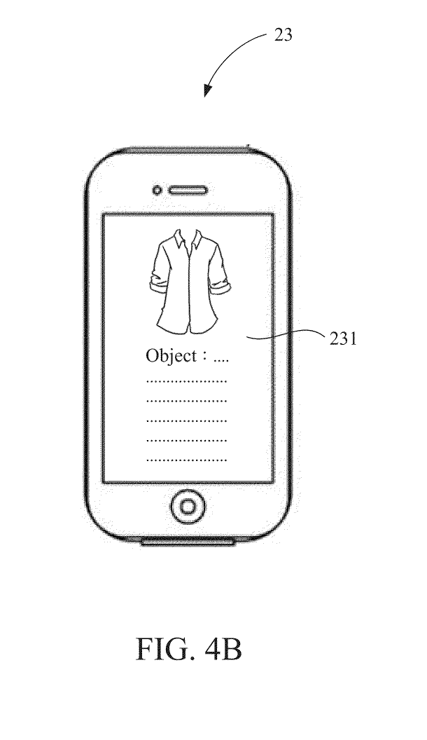

More specifically, FIG. 4A depicts the electronic apparatus 11, the video 13 played in the electronic apparatus 11, and the targeted object information 116 displayed in the electronic apparatus 11. In the embodiment, the display unit 111 plays the video 13 by a first display region 11a, and displays the targeted object information 116 related to the object 13b by a second display region 11b after receiving the targeted object information 116. However, in other embodiments, the display unit 111 may display the targeted object information 116 related to the object 13b by a single display region after stopping playing the video 13. Those of ordinary skill in the art may readily appreciate how the display unit 111 of the electronic apparatus 11 of the present invention plays the video 13 and display the targeted object information 116 according to other manners, so this will not be further described herein.

In addition, after the transceiver 119 receives the targeted object information 116 from the processor 115, the transceiver 119 transmits the targeted object information 116 to the user device 23 through the Internet 21. The user device 23 has a display unit 231 as shown in FIG. 4B. In the embodiment, the display unit 231 of the user device 23 displays the targeted object information 116 related to the object 13b after the user device 23 receives the targeted object information 116 from the Internet 21.

Accordingly, in the embodiment, the display unit 111 of the electronic apparatus 11 and the display unit 231 of the user device 23 simultaneously display the targeted object information 116 related to the object 13b. However, in other embodiments, the user may only set up the display unit 111 of the electronic apparatus 11 or only set up the display unit 231 of the user device 23 to display the targeted object information 116. Those of ordinary skill in the art may readily appreciate how the display unit 111 of the electronic apparatus 11 or the display unit 231 of the user device 23 of the present invention displays the targeted object information 116 according to different requirements, so this will not be further described herein.

The processor 115 transmits an update signal 118 to the transceiver 119 at an initial period. The initial period may be set up by the user as a day, a week, or a month. In the embodiment, the initial period may is set up as a day. More specifically, the processor 115 searches a plurality of updating object information 120 from the Internet 21 via the transceiver 119 according to the update signal 118. Afterward, the transceiver 119 transmits the updating object information 120 to the processor 115. The processor 115 transmits the updating object information 120 to the storage device 117 after receiving the updating object information 120 from the transceiver 119. Finally, the database 1171 of the storage device 117 stores the updating object information 120. Accordingly, the database 1171 of the storage device 117 may regularly update object information to prevent the user from not retrieving the targeted object information related to the object.

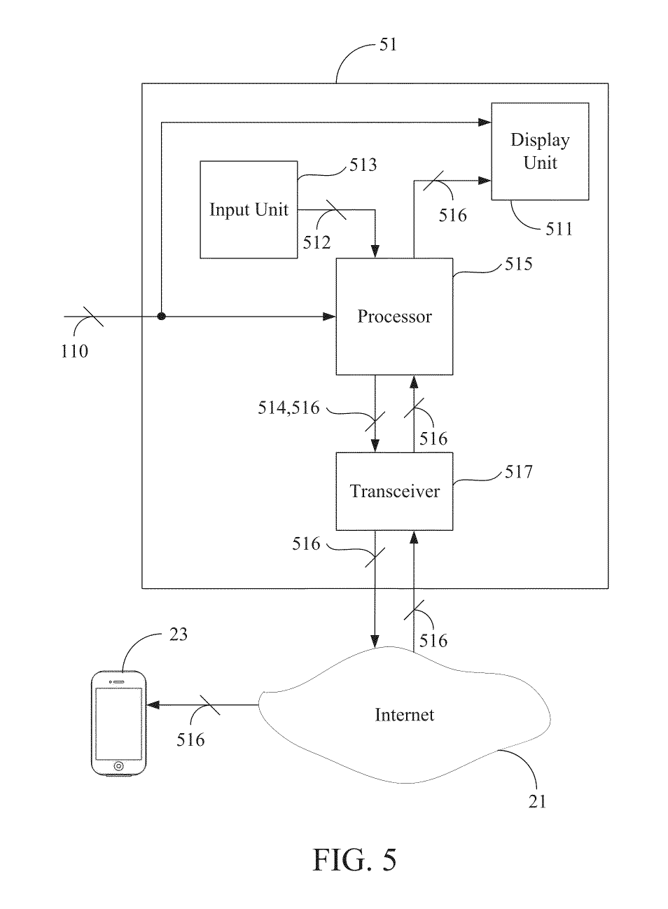

FIG. 5 depicts the Internet 21, the user device 23, and a second embodiment of the present invention, which is the electronic apparatus 51. The electronic apparatus 51 comprises a display unit 511, an input unit 513, a processor 515, and a transceiver 517. The processor 515 is electrically connected to the display unit 511, the input unit 513, and the transceiver 517. In the embodiment, the input unit 513 is the same as the input unit 113 of the electronic apparatus 11. The display unit 511 is the same as the display unit 111 of the electronic apparatus 11.

The display unit 511 receives the video signal 110 having the video 13, and playing the video 13 according to the video signal 110. As shown in FIG. 3A, the video 13 comprises a plurality of frames 131, 132, 133, . . . , 13n. Each of the frames 131, 132, 133, . . . , 13n has a plurality of objects 13a, 13b, 13c. When the display unit 511 displays the frame 136 of the video 13 as shown in FIG. 3B and a user selects the object 13b through the input unit 513, the input unit 513 generates an input signal 512 in response to the selection of the object 13b and transmits the input signal 512 to the processor 515. After receiving the video signal 110 and the input signal 512, the processor 515 identifies the object 13b to obtain an identify result according to the video signal 110 and the input signal 512. The processor 515 generates a search signal 514 and transmits the search signal 514 to the transceiver 517.

After receiving the search signal 514, the transceiver 517 retrieves targeted object information 516 related to the object 13b from the Internet 21 according to the search signal 514 and transmits the targeted object information 516 to the processor 515. Afterward, the processor 515 transmits the targeted object information 516 to the display unit 511 and the transceiver 517.

More specifically, FIG. 4A depicts the electronic apparatus 51, the video 13 played in the electronic apparatus 51, and the targeted object information 516 displayed in the electronic apparatus 51. In the embodiment, the display unit 511 plays the video 13 by a first display region 11a, and displays the targeted object information 516 related to the object 13b by a second display region 11b after receiving the targeted object information 516. However, in other embodiments, the display unit 511 may display the targeted object information 516 related to the object 13b by a single display region after stopping playing the video 13. Those of ordinary skill in the art may readily appreciate how the display unit 511 of the electronic apparatus 51 of the present invention plays the video 13 and display the targeted object information 516 according to other manners, so this will not be further described herein.

In addition, after the transceiver 517 receives the targeted object information 516 from the processor 515, the transceiver 517 transmits the targeted object information 516 to the user device 23 through the Internet 21. The user device 23 has the display unit 231 as shown in FIG. 4B. In the embodiment, the display unit 231 of the user device 23 displays the targeted object information 516 related to the object 13b after the user device 23 receives the targeted object information 516 from the Internet 21.

Accordingly, in the embodiment, the display unit 511 of the electronic apparatus 51 and the display unit 231 of the user device 23 simultaneously display the targeted object information 516 related to the object 13b. However, in other embodiments, the user may only set up the display unit 511 of the electronic apparatus 51 or only set up the display unit 231 of the user device 23 to display the targeted object information 516. Those of ordinary skill in the art may readily appreciate how the display unit 511 of the electronic apparatus 51 or the display unit 231 of the user device 23 of the present invention displays the targeted object information 516 according to different requirements, so this will not be further described herein.

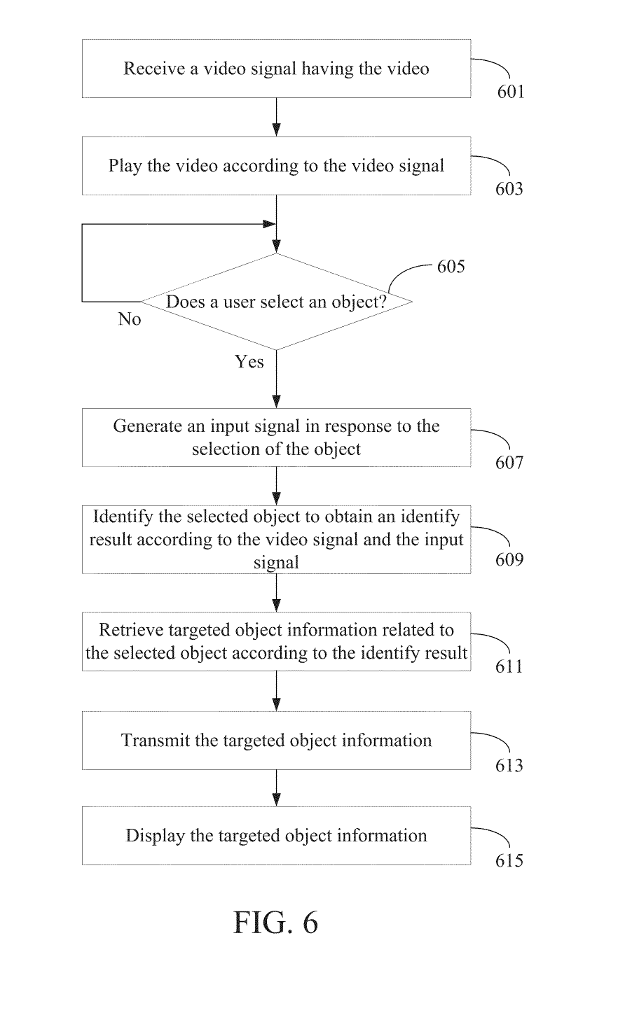

As shown in FIG. 6, a third embodiment of the present invention is an object information search method of video played in an electronic apparatus. The object information search method is adapted for the electronic apparatus 11 described in the first embodiment. The electronic apparatus comprises a display unit, an input unit, a processor, a storage device storing a database, and a transceiver. The processor is electrically connected to the display unit, the input unit, the storage device, and the transceiver. The video comprises a plurality of frames. One of the frames has at least one object.

In the third embodiment, the object information search method comprises the following steps. Initially, step 601 is executed to receive a video signal having the video via the display unit. Step 603 is executed to play the video according to the video signal via the display unit. Next, step 605 is executed to determine whether a user selects an object via the input unit. If the user does not select an object in step 605, step 605 is executed once again. If the user selects an object in step 605, step 607 is executed to generate an input signal in response to the selection of the object via the input unit.

Step 609 is executed to identify the selected object to obtain an identify result according to the video signal and the input signal via the processor after the processor receives the video signal and the input signal. Then, step 611 is executed to retrieve targeted object information related to the selected object according to the identify result via the processor. Afterward, step 613 is executed to transmit the targeted object information to the display unit or a user device via the processor. Finally, step 615 is executed to display the targeted object information via the display unit or the user device.

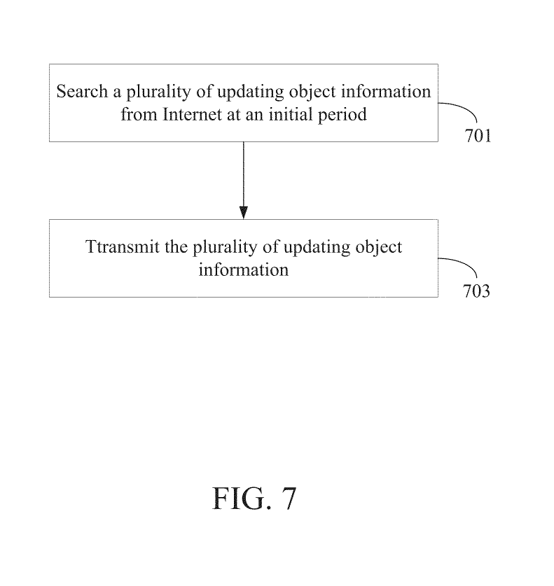

In the third embodiment, the object information search method further comprises the following steps of storing updating object information as shown in FIG. 7. Step 701 is executed for the processor to search a plurality of updating object information from Internet via the transceiver at an initial period. Next, step 703 is executed to transmit the plurality of updating object information to the database of the storage device via the processor.

In addition to the aforesaid steps, the third embodiment can also execute all the operations and functions set forth in the first embodiment. How the object information search method for an electronic apparatus of the present invention executes these operations and functions will be readily appreciated by those of ordinary skill in the art based on the explanation of the first embodiment and, thus, will not be further described herein.

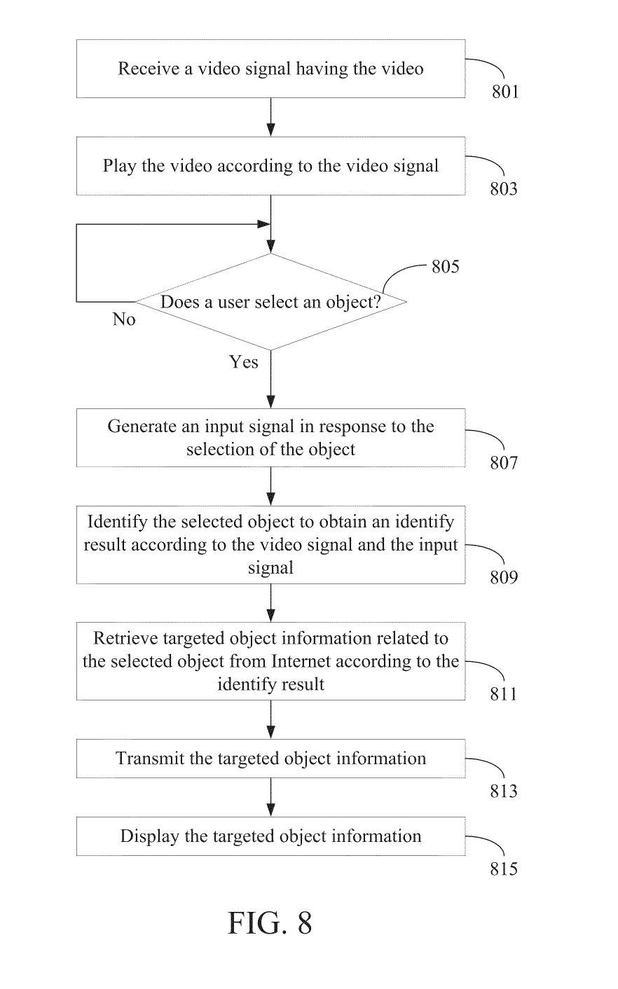

As shown in FIG. 8, a fourth embodiment of the present invention is an object information search method of video played in an electronic apparatus. The object information search method is adapted for the electronic apparatus 51 described in the second embodiment. The electronic apparatus comprises a display unit, an input unit, a processor, and a transceiver. The processor is electrically connected to the display unit, the input unit, and the transceiver. The video comprises a plurality of frames. One of the frames has at least one object.

In the fourth embodiment, the object information search method comprises the following steps. Initially, step 801 is executed to receive a video signal having the video via the display unit. Step 803 is executed to play the video according to the video signal via the display unit. Next, step 805 is executed to determine whether a user selects an object via the input unit. If the user does not select an object in step 805, step 805 is executed once again. If the user selects an object in step 805, step 807 is executed to generate an input signal in response to the selection of the object via the input unit.

Step 809 is executed to identify the selected object to obtain an identify result according to the video signal and the input signal via the processor after the processor receives the video signal and the input signal. Then, step 811 is executed for the processor to retrieve targeted object information related to the selected object from Internet according to the identify result via the transceiver. Afterward, step 813 is executed to transmit the targeted object information to the display unit or a user device via the processor. Finally, step 815 is executed to display the targeted object information via the display unit or the user device.

In addition to the aforesaid steps, the fourth embodiment can also execute all the operations and functions set forth in the second embodiment. How the object information search method for an electronic apparatus of the present invention executes these operations and functions will be readily appreciated by those of ordinary skill in the art based on the explanation of the second embodiment and, thus, will not be further described herein.

More specifically, the object information search method of the third and the fourth embodiments may be implemented by a computer program product. When the computer program product is loaded into the electronic apparatus 11, 51 via a computer and a plurality of codes of the computer program product is executed, the object information search method of the third and the fourth embodiments can be accomplished. This computer program product may be stored in a non-transitory tangible computer readable medium, such as a read only memory (ROM), a flash memory, a floppy disk, a hard disk, a compact disk, a mobile disk, a magnetic tape, a database accessible to networks, or any other storage media with the same function and well known to those skilled in the art.

According to the above description, when playing video comprising a plurality of frames, the electronic apparatus according to the present invention can retrieve targeted object information related to an object selected by a user in one of the frames of the video. Then the electronic apparatus displays the targeted object information related to the object, or transmits the targeted object information related to the object to a predetermined user device through Internet. Accordingly, the electronic apparatus of the present invention can effectively overcome the problem of the prior art that, the record for the category and the appearance of various products from a user is rougher to reduce the speed and accuracy for searching information of each product.

The above embodiments merely give the detailed technical contents of the present invention and inventive features thereof, and are not to limit the covered range of the present invention. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An electronic apparatus for searching object information of video, the video comprising a plurality of frames, one of the frames having at least one object, the electronic apparatus comprising:
a display unit configured for receiving a video signal having the video, and playing the video according to the video signal;
an input unit configured for generating an input signal in response to a selection of the at least one object: and
a processor, electrically connected to the display unit and the input unit, configured for receiving the video signal and the input signal, identifying the at least one object to obtain an identify result according to the video signal and the input signal, retrieving targeted object information related to the at least one object according to the identify result, and transmitting the targeted object information to one of the display unit and a user device.

2. The electronic apparatus as claimed in claim 1, further comprising a transceiver electrically connected to the processor, wherein the processor retrieves the targeted object information related to the at least one object from Internet according to the identify result via the transceiver.

3. The electronic apparatus as claimed in claim 1, further comprising a storage device electrically connected to the processor, wherein the storage device stores a database storing a plurality of object information, and the processor retrieves the targeted object information related to the at least one object from the plurality of object information stored in the database according to the identify result.

4. The electronic apparatus as claimed in claim 3, further comprising a transceiver electrically connected to the processor, wherein the processor searches a plurality of updating object information from Internet via the transceiver at an initial period, and transmits the plurality of updating object information to the database of the storage device.

5. The electronic apparatus as claimed in claim 1, wherein the display unit has a first display region and a second display region, the first display region is configured for playing the video, and the second display region is configured for displaying the targeted object information transmitted from the processor.

6. An object information search method of video played in an electronic apparatus, the electronic apparatus comprising a display unit, the video comprising a plurality of frames, one of the frames having at least one object, the object information search method of video comprising the following steps of:
receiving a video signal having the video;
playing the video according to the video signal;
generating an input signal in response to a selection of the at least one object;
receiving the video signal and the input signal;
identifying the at least one object to obtain an identify result according to the video signal and the input signal;
retrieving targeted object information related to the at least one object according to the identify result; and
transmitting the targeted object information to one of the display unit and a user device.

7. The object information search method of video as claimed in claim 6, wherein the electronic apparatus further comprises a transceiver, and the object information search method of video comprises the following step of:
retrieving the targeted object information related to the at least one object from Internet according to the identify result via the transceiver.

8. The object information search method of video as claimed in claim 6, wherein the electronic apparatus further comprises a storage device, the storage device stores a database storing a plurality of object information, and the object information search method of video comprises the following step of:
retrieving the targeted object information related to the at least one object from the plurality of object information stored in the database according to the identify result.

9. The object information search method of video as claimed in claim 8, wherein the electronic apparatus further comprises a transceiver, and the object information search method of video comprises the following steps of:
searching a plurality of updating object information from Internet via the transceiver at an initial period; and
transmitting the plurality of updating object information to the database of the storage device.

10. The object information search method of video as claimed in claim 6, wherein the display unit of the electronic apparatus has a first display region and a second display region, and the object information search method of video comprises the following steps of:
playing the video in the first display region of the display unit; and
displaying the targeted object information transmitted from the processor in the second display region of the display unit.

11. A non-transitory tangible computer readable medium, being stored with a computer program, the computer program executing an object information search method of video played in an electronic apparatus after being loaded into the electronic apparatus, the electronic apparatus comprising a display unit, the video comprising a plurality of frames, one of the frames having at least one object, and the object information search method of video comprising the following steps of:
receiving a video signal having the video;
playing the video according to the video signal;
generating an input signal in response to a selection of the at least one object;
receiving the video signal and the input signal;
identifying the at least one object to obtain an identify result according to the video signal and the input signal;
retrieving targeted object information related to the at least one object according to the identify result; and
transmitting the targeted object information to one of the display unit and a user device.

12. The non-transitory tangible computer readable medium as claimed in claim 11, wherein the electronic apparatus further comprises a transceiver, and the object information search method of video comprises the following step of:
retrieving the targeted object information related to the at least one object from Internet according to the identify result via the transceiver.

13. The non-transitory tangible computer readable medium as claimed in claim 11, wherein the electronic apparatus further comprises a storage device, the storage device stores a database storing a plurality of object information, and the object information search method of video comprises the following step of:
retrieving the targeted object information related to the at least one object from the plurality of object information stored in the database according to the identify result.

14. The non-transitory tangible computer readable medium as claimed in claim 13, wherein the electronic apparatus further comprises a transceiver, and the object information search method of video comprises the following step of:
searching a plurality of updating object information from Internet via the transceiver at an initial period; and
transmitting the plurality of updating object information to the database of the storage device.

15. The non-transitory tangible computer readable medium as claimed in claim 11, wherein the display unit of the electronic apparatus has a first display region and a second display region, and the object information search method of video comprises the following step of:
playing the video in the first display region of the display unit; and
displaying the targeted object information transmitted from the processor in the second display region of the display unit.
